(19) United States
(12) Patent Application Publication
(10) Pub. No.: US 2026/0067034 A1
(43) Pub. Date: Mar. 5, 2026

(54) DYNAMIC HYBRID BOUNDED AND UNBOUNDED DATA SEQUENCE

(71) Applicant: International Business Machines Corporation, Armonk, NY (US)

(72) Inventors: Albert Alexander Chung, Cary, NC (US); Alexander Dalton Chung, Cary, NC (US); Jean Detoeuf, Mérignac (FR)

(73) Assignee: International Business Machines Corporation, Armonk, NY (US)

(21) Appl. No.: 18/816,362

(22) Filed: Aug. 27, 2024

(51) Int. Cl. H04L 1/1607; H04L 1/1812

(52) U.S. Cl. CPC H04L 1/1607; H04L 1/1812

(57) ABSTRACT

An embodiment includes detecting a first data sequence by a system. The embodiment includes responsive to the detecting, determining by the system in real time whether a number of datapoints in the first data sequence is expressible as an expression. The embodiment also includes responsive to the determining, deciding to transform a datapoint in the first data sequence to the expression in a second data sequence wherein the first data sequence is transformed to the second data sequence.

### BACKGROUND

The present invention relates generally to data management. More particularly, the present invention relates to a method, system, and computer program for Dynamic hybrid bounded and unbounded data sequence.

In Application Performance Monitoring (APM) domain, “observability” is a measure of how well the internal states of the system can be inferred by analyzing its external outputs. Metrics is one of the three pillars of “observability” (the other two being logs and traces). Metrics are collected by telemetry library/agents at regular intervals then sent to APM backends for storage, processing and consumption by humans or machines. Each component if monitored by APM can emit metrics or APM agent can discover and retrieve metrics from these components. Metrics collection rates may be configured by the APM. For example, collection can be configured to once per second. The number of components, the number of metrics collected from each component and the frequency of the metric collection can add up to large quantity of data that need to be transmitted to the APM backend.

Data centers that host applications are also monitored to easily identify trends, security threats and unusual activity, which is beneficial for both short-term and long-term data center management. These monitoring sensors, programs and functions generate, transmit, analyze and archive large chunks of data. Log management software is essential to make sense of the information found in log files and track trends for data center maintenance.

### SUMMARY

The illustrative embodiments provide for Dynamic hybrid bounded and unbounded data sequence. An embodiment includes detecting a first data sequence by a system. The embodiment includes responsive to the detecting, determining by the system in real time whether a number of datapoints in the first data sequence is expressible as an expression. The embodiment also includes responsive to the determining, deciding to transform a datapoint in the first data sequence to the expression in a second data sequence wherein the first data sequence is transformed to the second data sequence.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a system diagram in an environment in accordance with an illustrative embodiment;

FIG. 3 depicts a system diagram in an environment in accordance with an illustrative embodiment;

FIG. 4 depicts a diagram in accordance with an illustrative embodiment;

FIG. 5 depicts a flowchart diagram in accordance with an illustrative embodiment; and

FIG. 6 depicts a flowchart diagram in accordance with an illustrative embodiment.

### DETAILED DESCRIPTION

APM systems may be configured to collect metrics frequently. The number of components, the number of metrics collected from each component and the frequency of the metric collection can add up to large quantity of data that need to be transmitted to the APM backend. During normal operation, some metrics have values that can remain relatively unchanged or exhibit a certain pattern over time. Even though the values may have changed little, or there is a recognizable pattern, these metrics are still sent to the APM backend. Data center monitoring systems may collect room temperature metrics every second. The temperature reading collected is not likely to change much when compared to the previous n number of samples if the readings are taken frequently. Another example, the number of running pods in a Kubernetes cluster is not likely to change during normal operation over a span of time. Continuously sending metrics value that has not changed is an inefficient use of network resources. The metric collection intervals may be manually configured to to different metric collection intervals but setting a large collection interval may lead to loss of data precision. Some APM employ the technique of not sending the data if the datapoint is the same as the previous datapoint in value. This will derive some benefits, but it does not help if the data is changing but follows a certain pattern. For example, a counter metric can monotonically increase at a constant rate over time.

The present disclosure addresses the deficiencies described above by providing a process (as well as a system, method, machine-readable medium, etc.) for a Dynamic hybrid bounded and unbounded data sequence. The following description provides examples of embodiments of the present disclosure, and variations and substitutions may be made in other embodiments. Several examples will now be provided to further clarify various aspects of the present disclosure.

Example 1: A computer-implemented method that comprises detecting a first data sequence by a system. The method further comprises responsive to the detecting, determining by the system in real time whether a number of datapoints in the first data sequence is expressible as an expression. The method further comprises responsive to the determining, deciding to transform a datapoint in the first data sequence to the expression in a second data sequence where the first data sequence is transformed to the second data sequence.

The above limitations advantageously enable transforming in real time a datapoint of a first data sequence that fits a pattern to an expression in a second data sequence. Aspects of the present disclosure improve the space efficiency of data sequences by requiring less bytes to represent the data in the second data sequence. The smaller size of the second data sequence reduces storage and network usage.

Embodiments disclosed herein describe detecting as the system sensing data from data sources of the network. In other embodiments, the system monitors data sources from multiple dimensions and types of data, which can include data collected from computer memory, monitoring systems, including environment data, device operation data, and inspection data.

A data sequence as referred to herein may or may not include a time series data stream. A data sequence may also be a sequence comprising a counter and a corresponding value. Embodiments disclosed herein describe data sequence in the APM system environment; however, use of this example is not intended to be limiting, but is instead used for descriptive purposes only. Instead, the data sequence may be generated in other system including but not limited to sensors, instruments, and communication systems.

The term real time as depicted herein may include the immediate or contemporaneous processing of the data sequence at the same time that it is detected by the system. In embodiments, when the first data sequence is detected, the datapoints are immediately processed.

An expression as referred to herein may or may not include text, real number, binary number, hexadecimal number, function, symbol or other representations of data and combinations thereof. In an embodiment, the expression may be a constant real number that represents a temperature metric of a datacenter. In another embodiment, the expression may be a symbol representing a group of datapoints for particular timestamps from an APM system that monitors distributed tracing of a system.

To transform a datapoint as described herein may or may not include converting a value of a datapoint in a first data sequence to a different value or a different state in a second data sequence. In an embodiment, a datapoint value may be transformed to an expression. In another embodiment, a datapoint value may be transformed into a binary number. In another embodiment, a datapoint is transformed when a datapoint in a first data sequence is copied to a second data sequence.

Example 2: The limitations of Example 1, where responsive to the determining, deciding to copy a datapoint in the first data sequence to the second data sequence.

The above limitations advantageously enable determining that a datapoint of a first data sequence does not fit a pattern and is not expressible as an expression. The datapoint is copied to a second data sequence. A datapoint that may not be expressed as an expression does not fit a pattern so it may represent an interesting datapoint to monitoring systems. Additionally, the limitations realize the benefits described with respect to Example 1.

Example 3: The limitations of Example 1, where the second data sequence comprises of a hybrid bounded and unbounded data sequence.

The above limitations advantageously enable a data sequence comprising an expression, and a datapoint in the second data sequence. In embodiments described herein, the term bounded may or may not include a bound for datapoints of the first data sequence for which the system determines whether the datapoints within the bound are expressible as an expression. If expressible as an expression, a datapoint is transformed into an expression in the second data sequence. The unbounded data would be the remaining data that cannot be efficiently represented by an expression. Hence, the second data sequence is a hybrid bounded and unbounded data sequence where the second sequence comprises of a combination of transformed expressions and original data points. Additionally, the limitations realize the benefits described with respect to Examples 1-2.

Example 4: The limitations of Example 1, further comprising comparing the datapoint in the first data sequence with the expression to determine whether to transform the datapoint.

The above limitations advantageously enable determining whether a datapoint in the first data sequence is expressed by a previous expression. In embodiments, this determination ensures successive datapoints are compared to a previously determined expression to decide to transform the datapoint in the second data sequence. Additionally, the limitations realize the benefits described with respect to Examples 1-3.

Example 5: The limitations of Example 1 where the determining comprises deriving the expression from the number of datapoints in the first data sequence.

The above limitations advantageously enable the determination of the expression by deriving the expression from a number of datapoints in the first data sequence. In embodiments, the deriving comprises applying a regression algorithm on the datapoints. Additionally, the limitations realize the benefits described with respect to Examples 1-4.

Example 6: The limitations of Example 1 comprising detecting the expression from the second data sequence, responsive to the detecting, deciding to compute a datapoint based on the expression.

The above limitations advantageously enable computing a datapoint from an expression of the second data sequence. Additionally, the limitations realize the benefits described with respect to Examples 1-5.

Example 7: The limitations of Example 1 where the number of datapoints in the first data sequence is predefined.

The above limitations advantageously enable the data bound to be predefined. In the embodiments described herein, a data bound for datapoints of the first data sequence is the number of datapoints the first data sequence for which the system determines whether the datapoints are expressible as an expression. Additionally, the limitations realize the benefits described with respect to Examples 1-6.

Example 8: A computer program product comprising one or more computer readable storage media, and program instructions collectively stored on the one or more computer readable storage media, the program instructions executable by a processor to cause the processor to perform the method according to any of Examples 1-7. The computer program product of Example 8 realizes the benefits described with respect to Examples 1-7. The computer program product of Example 8 can advantageously be implemented into a variety of computer program products.

Example 9: A computer system comprising a processor and one or more computer readable storage media, and program instructions collectively stored on the one or more computer readable storage media, the program instructions executable by the processor to cause the processor to perform the method according to any of Examples 1-7. The computer system of Example 9 realizes the benefits described with respect to Examples 1-7. The computer system of Example 9 can advantageously be implemented into a variety of computer devices.

Example 10: A computer-implemented method that comprises detecting a first data sequence by a system. The method further comprises responsive to the detecting, determining by the system in real time whether a number of datapoints in the first data sequence is expressible as an expression. The method further comprises responsive to the determining, deciding to transform a datapoint in the first data sequence to the expression in a second data sequence where the first data sequence is transformed to the second data sequence. The method further comprises where the second data sequence comprises of a hybrid bounded and unbounded data sequence. The method further comprises where responsive to the determining, deciding to copy a datapoint in the first data sequence to the second data sequence. The method further comprises comparing a datapoint in the first data sequence with a previously determined expression to determine whether to transform the datapoint. The method further comprises where the determining comprises deriving the expression from the number of datapoints in the first data sequence. The above limitations realize the technical benefits described with respect to Examples 1-7.

Example 11: A computer program product comprising one or more computer readable storage media, and program instructions collectively stored on the one or more computer readable storage media, the program instructions executable by a processor to cause the processor to perform the method according to Example 10. The computer program product of Example 11 realizes the technical benefits described with respect to Examples 1-7. The computer program product of Example 11 can advantageously be implemented into a variety of computer program products.

Example 12: A computer system comprising a processor and one or more computer readable storage media, and program instructions collectively stored on the one or more computer readable storage media, the program instructions executable by the processor to cause the processor to perform the method according to Example 10. The system of Example 12 realizes the benefits of Examples 1-7. The system of Example 12 can advantageously be implemented into a variety of computing devices.

Aspects of the present disclosure can be implemented in a variety of technical use cases. The following use cases are merely exemplary and are not intended to limit the scope of the disclosure.

In a use case, an APM system monitors software services and applications in real time, collecting detailed performance information on response time for incoming requests, database queries, calls to caches, and external HTTP requests. This makes it easier to pinpoint and fix performance problems quickly. The APM system comprises of APM Agents that instrument code and collect performance data and errors at runtime in a data sequence. The data sequence may be buffered for a short period and sent on to the APM Server. The APM Server runs on dedicated server and listens on a network port, to detect and receive the first data sequence from the APM Agents through API endpoints. The endpoint can be receive data in HTTP JSON format, or binary formats like Protobuf or gRPC. A user defined data bound is preconfigured to n=3. The data pattern recognizer of the APM Server applies a regression algorithm on the first data sequence to determine if n=3 datapoints may be expressed as an expression. A decision is made whether to transform the datapoint in the first data sequence to an expression in the second data sequence. If yes, the expression expresses the bounded datapoints. If no, the datapoint in the first data sequence is copied to the second data sequence as an unbounded datapoint. At the same time, subsequent datapoints in the first data sequence are compared with the previously derived expression to determine whether to transform the subsequent datapoint. Thus, the second data sequence is a hybrid bounded and unbounded data sequence.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

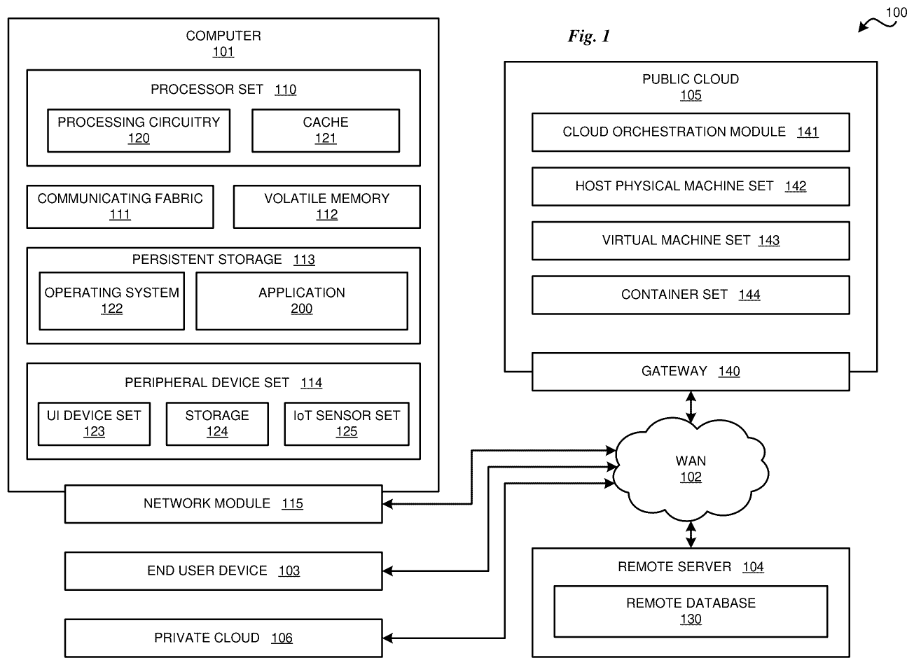

With reference to FIG. 1, this figure depicts a block diagram of a computing environment 100. Data center environment 100 contains an example of an environment for the execution of at least some of the computer code involved in performing the inventive methods, such as an Application module 200 that provides Dynamic hybrid bounded and unbounded data sequence. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

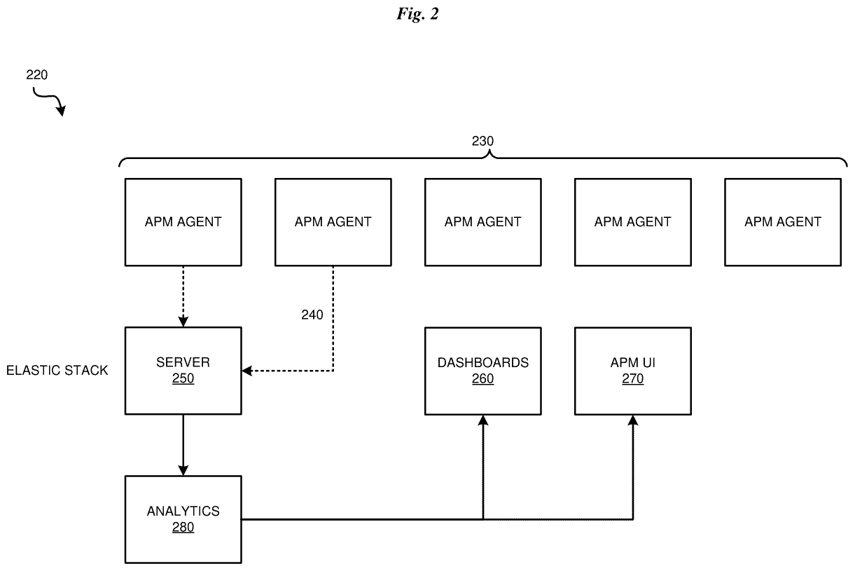

FIG. 2 depicts a system diagram in an environment in accordance with an illustrative embodiment. In a particular embodiment, the components of the diagram 220 show aspects of the Application 200 of FIG. 1.

In the illustrated embodiment, an application performance monitoring (APM) system 220 monitors software services and applications in real time, collecting detailed performance information on response time for incoming requests, database queries, calls to caches, external HTTP requests, etc. This makes it easier to pinpoint and fix performance problems quickly. The APM system may also automatically collect unhandled errors and exceptions. Errors are grouped based primarily on the stack trace, so new errors may be identified as they appear.

In embodiments, APM agents 230 instrument code and collect performance data and errors at runtime. This data may be a data sequence and is sent 240 on to Server 250. The Server runs on dedicated server and listens on a network port, to detect and receive the first data sequence from the APM Agents through a JavaScript Object Notation (JSON) Hypertext Transfer Protocol (HTTP) application programming interface. In some embodiments, the data sequence may be a time series data stream. In another embodiment, the data sequence may be a sequence comprising a counter and a corresponding value. The data is analyzed by performing analytics 280. In some embodiments, the data may be searched, viewed, and interacted with through the dashboards 260 and APM user interfaces (UI) 270.

Embodiments disclosed herein describe data sequence in the APM system environment; however, use of this example is not intended to be limiting, but is instead used for descriptive purposes only. Instead, the data sequence may be generated in other system including but not limited to sensors, instruments, and communication systems. For example, data centers that host applications are also monitored to easily identify trends, security threats and unusual activity. These monitoring sensors, programs and functions generate, transmit, analyze and archive large data sequences.

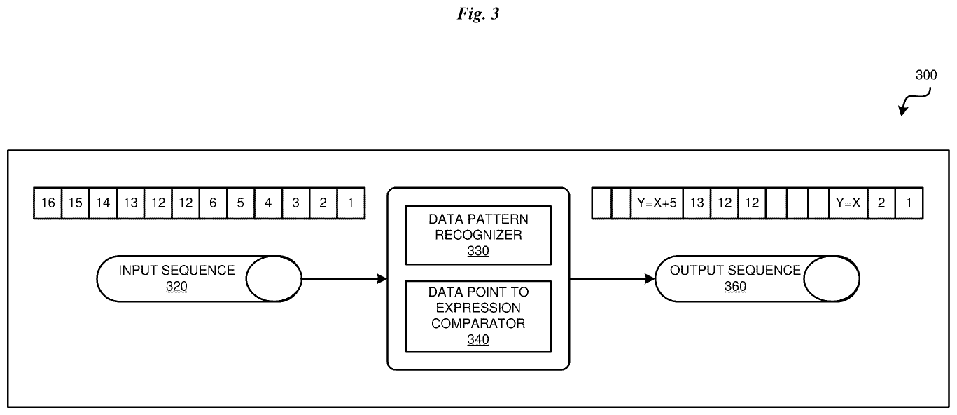

FIG. 3 depicts a system diagram in an environment in accordance with an illustrative embodiment. In a particular embodiment, the components of the diagram 300 show aspects of the Application 200 of FIG. 1.

In the illustrated embodiment, the input first data sequence 320 is detected by a system comprising data pattern recognizer 330 and a datapoint to expression comparator 340. In embodiments, the system detects data from data sources of the network. In other embodiments, the data sources are monitored and comes from multiple dimensions and types of data, which can include data collected from computer memory, monitoring systems, including environment data, device operation data, and inspection data.

In an embodiment, an output second data sequence 360 is output from the system. For example, the data sequences may be stored temporarily in a known buffer memory such as a single-port clock-synchronous volatile memory and operates in a first in, first out (FIFO) manner. Higher speed of the buffer memory and easy access control can be realized. The nonvolatile memory is, for example, a flash memory. A data controller may manage the in and out transfer of data from the buffer memory.

In an embodiment, the data pattern recognizer 330 is configured to determine in real time whether a number of datapoints in the first data sequence is expressible as an expression. In embodiments, initially, the data pattern recognizer is configured with the data bound n datapoints (where initial n can be configurable). The data bound n may be elastic, that is, the value of n may be modified to be a smaller or larger number. In embodiments, n is configurable, for example, configured in real time, according to a schedule or pre-configured.

In an embodiment, the data pattern recognizer then uses known regression functions including but not limited to, square regression, polynomial regression, exponential regression, logarithmic regression, and power-law regression to determine the expression that expresses the n datapoints. It then calculates the expression parameters using the chosen fitting method. The data pattern recognizer may use a central processing unit (CPU) or a graphics processing unit (GPU) that can perform computations at high speed. In other embodiments, the data pattern recognizer may use machine learning techniques such as linear regression, polynomial regression, logistic regression and lasso regression in a neural network implemented with CMOS digital circuits, Resistive Random Access Memory (RRAM) or similar technologies.

In some embodiments, the datapoint to expression comparator 340 compares the next incoming datapoint in the first data sequence against the expression to see if the datapoint value deviates from what the expression expects it to be. The datapoint to expression comparator may be implemented using random access memory and a CPU where the CPU reads and writes the datapoints to the memory.

In other embodiments, a decision is made whether to transform a datapoint in a first data sequence to the expression in a second data sequence as explained below. For example, if the transformation takes place, the system may write the expression to the second data sequence as a character string using a CPU writing to a memory. In another embodiment, the expression may be written as a binary string to the memory.

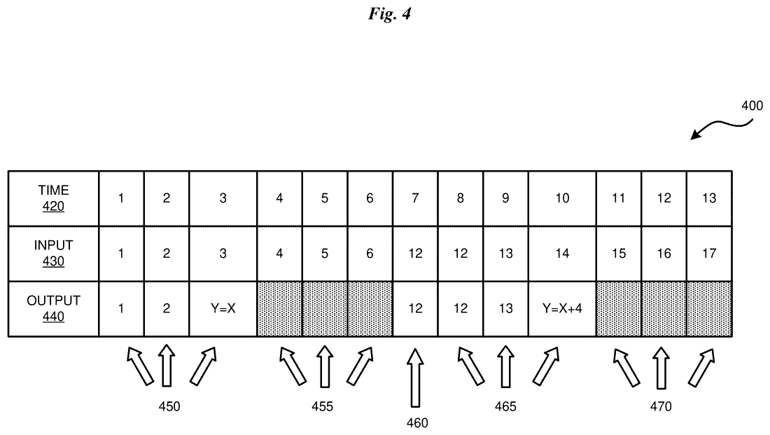

FIG. 4 depicts a diagram in accordance with an illustrative embodiment. In a particular embodiment, the components of the diagram 400 are representative of aspects of the Application 200 of FIG. 1.

In the illustrated embodiment, using an example to illustrate the concept, two data sequences based on time 420 comprise the input data sequence 430, and the output data sequence 440. In this example, the data bound is set to n=3. The data pattern recognizer then ingests the input data sequence 430. For example, from the first 3 datapoints, the data pattern recognizer applies a regression algorithm to determine that the expression is linear (a straight line to be precise). The mathematical function for a straight line in y=mx+c, where m is the slope, c is the y-intercept. In this example, the data pattern recognizer derives the expression y=x for the 3 datapoints. This expression is inserted into the hybrid bounded and unbounded output data sequence 440 along with an optional timestamp. In embodiments, the data pattern recognizer is not limited to simple math functions but may also determine complex formulas and relationships. In some embodiments, the derived expression is cached in buffer memory.

In some embodiments, the data pattern recognizer ingests the input data sequence 430 and checks whether a cached expression exists. If yes, the next incoming datapoint of the input data sequence is compared with the expression as explained below. If no, the determination of an expression is performed as explained above.

It should be noted that the term expression depicted herein may also include text, real number, binary number, hexadecimal number, symbol or other representations of data and combinations thereof. For example, the expression may be a constant real number that represents a temperature metric of a datacenter. In another example, the expression may be a symbol representing a group of datapoints for particular timestamps from an APM system that monitors distributed tracing of a system. The symbol may denote an event such as a temperature warning or network congestion.

In an embodiment, the expression, which may be retrieved from a cache in some embodiments, is compared with the next incoming datapoint in the first data sequence to determine if the datapoint value deviates from what the expression expects it to be. Continuing with the above example, the next datapoint is 4 at time location 4. Putting the timeslot 4 into the math function y=x, the output y=4. Comparing the datapoint value 4 to the y value, they are equal. Given they are equal, no value is inserted into the hybrid bounded and unbounded second data sequence 455. The same goes for the next two incoming datapoints. In some embodiments, if the value of the datapoint is equal to the y value, as in this example, a small value, such as a bit, is inserted into the second data sequence for the particular timeslot.

Referring to the example, the following datapoint value at timeslot 7 is 12 (460), and at timeslots 8 and 9 have values 12 and 13 respectively (465). When these datapoints are compared to the expression output, the result would not be equal. During the data comparison process, the data pattern recognizer is working in parallel to determine the next expression using the previous n values for the bound. If the comparison is not equal and the data pattern recognizer could not determine a new expression, the datapoint would be considered as unbounded data. In embodiments, any previously cached expression is then cleared from the cache. The datapoint is then inserted verbatim into the hybrid bounded and unbounded time series. Continuing with the inline processing, the next timeslot is 10. The data pattern recognizer at this point would output the equation y=x+4 from the previous 3 datapoints (12, 13 and 14). This expression is inserted into the hybrid bounded and unbounded time series for the timeslot 10. This completes one cycle and starts the next cycle of the processing. For the next three datapoints, the datapoint values would equal to the value calculated from the expression 470. For example, in such a case, there is no insertion into the output data sequence. In another example, an indicator such as an integer bit is inserted to minimally indicate that the value may be derived from the expression.

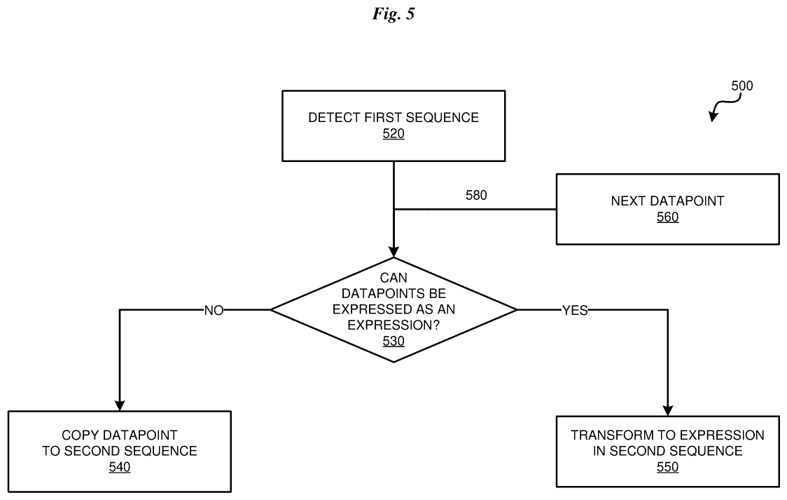

FIG. 5 depicts a flowchart diagram in an environment in accordance with an illustrative embodiment. In a particular embodiment, the components of the diagram 500 show aspects of the Application 200 of FIG. 1.

In the illustrated embodiment, the process starts at block 520 to detect the first sequence of data. For example, the system may sense a data sequence from the network. The detected data sequence may be read from the buffer memory and ready for processing. For example, if the data bound n=3, three datapoints are read from the buffer memory. Next at block 530, the process decides can the datapoints be expressed as an expression. In some embodiments, a previously derived expression is retrieved from a buffer memory cache if available. If the datapoints can be expressed as an expression, the process proceeds to block 550 where the datapoint from the data bound range is transformed into the expression in the second sequence. In some embodiments, the derived expression is cached in buffer memory. If the answer is no, copy datapoint to second sequence 540. A previously cached expression may also be purged. In some embodiments, concurrently 580 with some or all of the above steps, the next datapoint is processed 560 with the determination can the datapoints be expressed as an expression at block 530. For example, with the data bound of n=3, the current datapoint and two preceding datapoints are processed to determine if the datapoints be expressed as an expression.

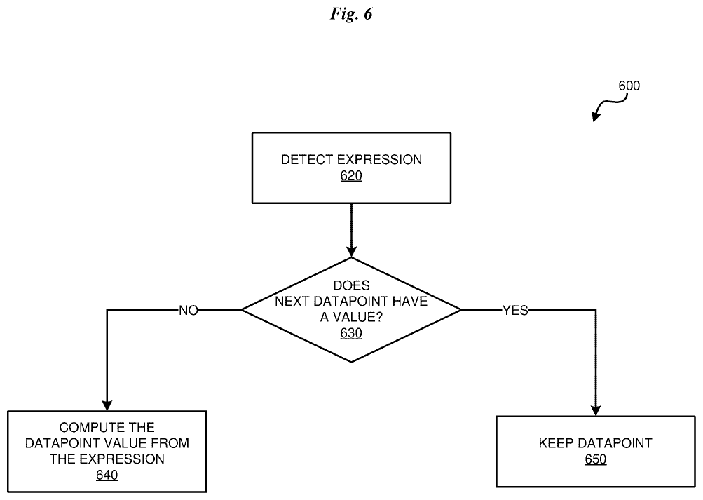

FIG. 6 depicts a flowchart diagram in accordance with an illustrative embodiment. In a particular embodiment, the components of the diagram 600 are representative of aspects of the Application 200 of FIG. 1.

In the illustrated embodiment, the process starts at block 620 to detect an expression. For example, the system may sense a character string of the expression from the network. The detected expression may be read from the buffer memory and ready for processing. Next at block 630, the process makes a decision does next datapoint have a value. In an embodiment, the system reads the next datapoint, for example, the timeslot that follows in the data sequence. If there is a value for this datapoint, the process continues to block 650 and the datapoint value is kept for the timeslot. If there is no value for the particular timeslot, the process computes the datapoint value from the expression 640. For example, using the expression y=x and the data sequence from the example above, the system will compute the datapoint values 3, 4, 5 and 6 for the timeslots 3, 4, 5, and 6 respectively.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
detecting a first data sequence by a system,
responsive to the detecting, determining by the system in real time whether a number of datapoints in the first data sequence is expressible as an expression; and
responsive to the determining, deciding to transform a datapoint in the first data sequence to the expression in a second data sequence wherein the first data sequence is transformed to the second data sequence.

2. The computer-implemented method of claim 1, wherein responsive to the determining, deciding to copy the datapoint in the first data sequence to the second data sequence.

3. The computer-implemented method of claim 1, wherein the second data sequence comprises of a hybrid bounded and unbounded data sequence.

4. The computer-implemented method of claim 1, further comprising comparing the datapoint in the first data sequence with the expression to determine whether to transform the datapoint.

5. The computer-implemented method of claim 1, wherein the determining comprises deriving the expression from the number of datapoints in the first data sequence.

6. The computer-implemented method of claim 1, further comprising detecting the expression from the second data sequence, responsive to the detecting, deciding to compute a datapoint based on the expression.

7. The computer-implemented method of claim 1, wherein the number of datapoints in the first data sequence is predefined.

8. A computer program product comprising one or more computer readable storage media, and program instructions collectively stored on the one or more computer readable storage media, the program instructions executable by a processor to cause the processor to perform operations comprising:
detecting a first data sequence by a system,
responsive to the detecting, determining by the system in real time whether a number of datapoints in the first data sequence is expressible as an expression; and
responsive to the determining, deciding to transform a datapoint in the first data sequence to the expression in a second data sequence wherein the first data sequence is transformed to the second data sequence.

9. The computer program product of claim 8, wherein responsive to the determining, deciding to copy the datapoint in the first data sequence to the second data sequence.

10. The computer program product of claim 8, wherein the second data sequence comprises of a hybrid bounded and unbounded data sequence.

11. The computer program product of claim 8, further comprising comparing the datapoint in the first data sequence with the expression to determine whether to transform the datapoint.

12. The computer program product of claim 8, wherein the determining comprises deriving the expression from the number of datapoints in the first data sequence.

13. The computer program product of claim 8, further comprising detecting the expression from the second data sequence, responsive to the detecting, deciding to compute a datapoint based on the expression.

14. The computer program product of claim 8, wherein the number of datapoints in the first data sequence is predefined.

15. A computer system comprising a processor and one or more computer readable storage media, and program instructions collectively stored on the one or more computer readable storage media, the program instructions executable by the processor to cause the processor to perform operations comprising:
detecting a first data sequence by a system,
responsive to the detecting, determining by the system in real time whether a number of datapoints in the first data sequence is expressible as an expression; and
responsive to the determining, deciding to transform a datapoint in the first data sequence to the expression in a second data sequence wherein the first data sequence is transformed to the second data sequence.

16. The computer system of claim 15, wherein responsive to the determining, deciding to copy the datapoint in the first data sequence to the second data sequence.

17. The computer system of claim 15, wherein the second data sequence comprises of a hybrid bounded and unbounded data sequence.

18. The computer system of claim 15, further comprising comparing the datapoint in the first data sequence with the expression to determine whether to transform the datapoint.

19. The computer system of claim 15, wherein the determining comprises deriving the expression from the number of datapoints in the first data sequence.

20. The computer system of claim 15, further comprising detecting the expression from the second data sequence, responsive to the detecting, deciding to compute a datapoint based on the expression.
